(19) United States
(12) Patent Application Publication
(10) Pub. No.: US 2025/0039728 A1
(43) Pub. Date: Jan. 30, 2025

(54) DATA TRANSFER WITH ENERGY HARVESTING

(71) Applicant: InterDigital Patent Holdings, Inc., Wilmington, DE (US)

(72) Inventors: Brian Martin, Farnham (GB); Erdem Bala, East Meadow, NY (US); Virgil Comsa, Montreal (CA); Keiichi Kubota, Tokyo (JP); Janet A. Stern-Berkowitz, Little Neck, NY (US)

(73) Assignee: InterDigital Patent Holdings, Inc., Wilmington, DE (US)

(21) Appl. No.: 18/697,126

(22) PCT Filed: Sep. 28, 2022
(86) PCT No.: PCT/US2022/045067

§ 371 Date: Mar. 29, 2024

Related U.S. Application Data
(60) Provisional application No. 63/250,076, filed on Sep. 29, 2021.
(60) Provisional application No. 63/344,357, filed on May 20, 2022.

(51) Int. Cl. H04W 28/02; H04W 72/232

(52) U.S. Cl. CPC H04W 28/0221; H04W 28/0278; H04W 72/232

(57) ABSTRACT

Systems, methods, and instrumentalities are described herein for data transfer with energy harvesting (EH). EH may offer zero-energy consumption data communication. EH may impose intermittent connection drops due to battery shortage. If a certain condition is met (e.g., battery shortage), the RRC state or DRX/DTX configuration may be switched and data transfer operation may be suspended. EH may be performed to charge the battery/capacitor of the WTRU in the changed RRC state (e.g., new RRC state) or in a changed DRX/DTX operation (e.g., new DRX/DTX operation). If the state is transitioned or the DRX/DTX configuration is changed, protocol times (e.g., via all protocol timers) may be suspended and the user data maintained so that the transmitter and the receiver entities may resume data communication without any data loss or with very small loss of data.

### CROSS-REFERENCE TO RELATED APPLICATIONS

This application claims the benefit of Provisional U.S. Patent Application No. 63/250,076, filed Sep. 29, 2021, and Provisional U.S. Patent Application No. 63/344,357, filed May 20, 2022, the disclosures of which are incorporated herein by reference in their entireties.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein that relate to data transfer with energy harvesting (EH).

A wireless transmit/receive unit (WTRU) associated with EH may be configured to send a request indicating a requested off time. The requested off time may correspond to a requested period of time associated with the WTRU entering a lower power operation (e.g., the WTRU powers off, operates in low power, and/or performs EH). The requested off time may correspond to a requested period of time associated with the WTRU stopping or pausing UL transmission, DL reception, and/or one or more other functions. The WTRU may receive a response (e.g., in response to the request). The response may be a message such as an EH response message. The response (e.g., the EH response message) may include information indicating one or more of: an off length of time (e.g., a period of time associated with the WTRU entering the lower power operation, where the off length of time may be the same or different than the requested off time); a configured grant (CG); resource(s) associated with the CG; or a CG validity time. The off length of time may be the length or duration of a time during which the WTRU may be or may stay in the lower power operation, where for example, the WTRU may exit the lower power operation if one or more conditions are satisfied or if the time period ends. The off length of time may be a time (e.g., time period) during which a WTRU harvests (e.g., obtains or derives) energy. The CG validity time may be a length of time or time period for which the CG resources are valid.

The WTRU may start a first time period (e.g., after receiving the response) based on the off length of time. The WTRU may start a second time period (e.g., after receiving the response) based on the CG validity time. The second time period (e.g., corresponding to the CG validity time) may begin after the first time period (e.g., corresponding to the off length of time received in the EH response) (e.g., the first period may be longer than the second time period). If at least the first time period and the second time period have not ended and one or more conditions are satisfied, the WTRU may transmit a power recovery indication in an uplink (UL) transmission (e.g., PUSCH transmission). The power recovery indication may be transmitted using resource(s) associated with the CG. The UL transmission (e.g., PUSCH transmission) may include an amount of UL data. The amount of UL data may be the amount of data that the WTRU may buffer. The UL transmission (e.g., the PUSCH transmission) may (e.g., may also) include a buffer status report.

The WTRU may receive an indication of a buffer threshold. In examples, the one or more conditions for transmitting a power recovery indication may be satisfied if UL data available for transmission exceeds the buffer threshold. In examples, the amount of UL data included in the UL transmission may be an amount of the UL data available for transmission that exceeds the buffer threshold. In examples, the one or more conditions may be satisfied if the WTRU has sufficient energy (e.g., a sufficient battery level) to transmit the amount of UL data that exceeds the buffer threshold. In examples, the one or more conditions may be satisfied if a power condition (e.g., the WTRU's battery level) is above a threshold (e.g., is above a battery level threshold).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of an ON duration and an OFF duration with a DRX cycle.

FIG. 3 illustrates an example of WUS and GOS with a DRX operation.

FIG. 4 illustrates an example of WTRU RRC state machine and state transitions (e.g., in NR).

FIG. 5 illustrates an example of two TM peer entities

FIG. 6 illustrates an example of a RRC state machine for an EH enabled WTRU.

FIG. 7 illustrates an example of an EH notification or EH request for the case of a state transition from a CONNECTED to POWER_OFF state.

FIG. 8 illustrates an example of a power recovery notification for the case of state transition from a POWER_OFF to RRC_CONNECTED state.

FIG. 9 illustrates an example of an EH DRX/DTX operation state machine.

FIG. 10 illustrates an example procedure for power savings and/or EH.

### DETAILED DESCRIPTION

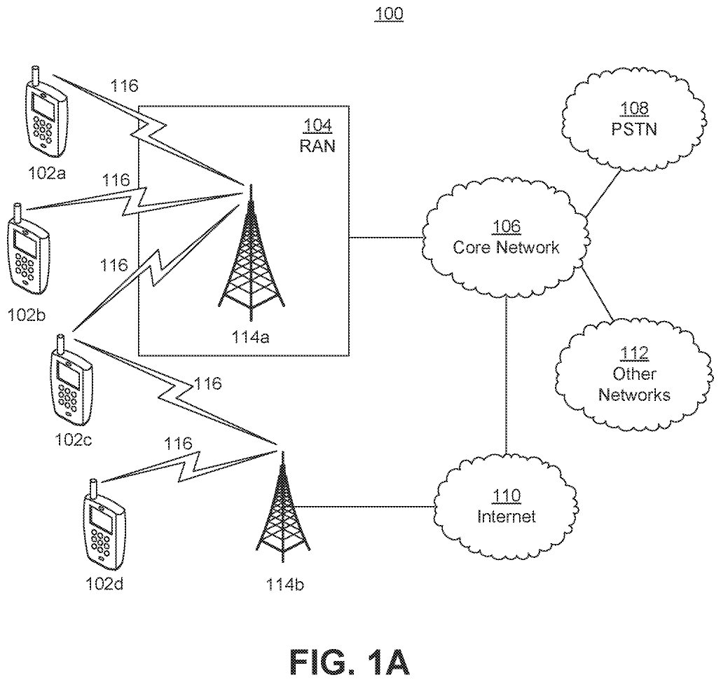

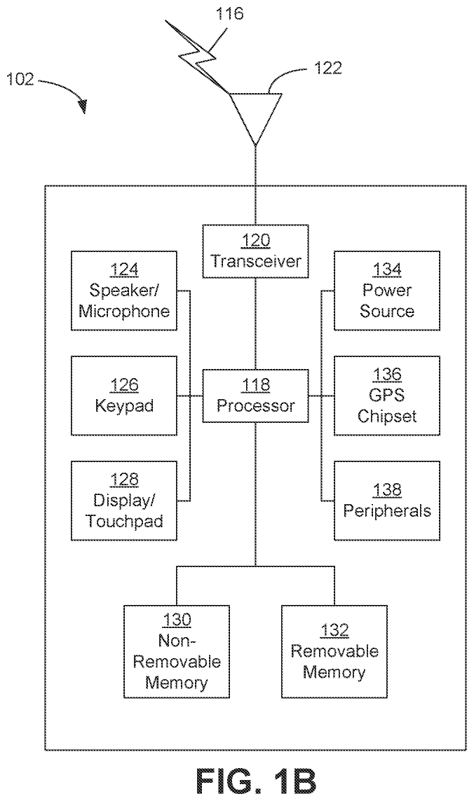

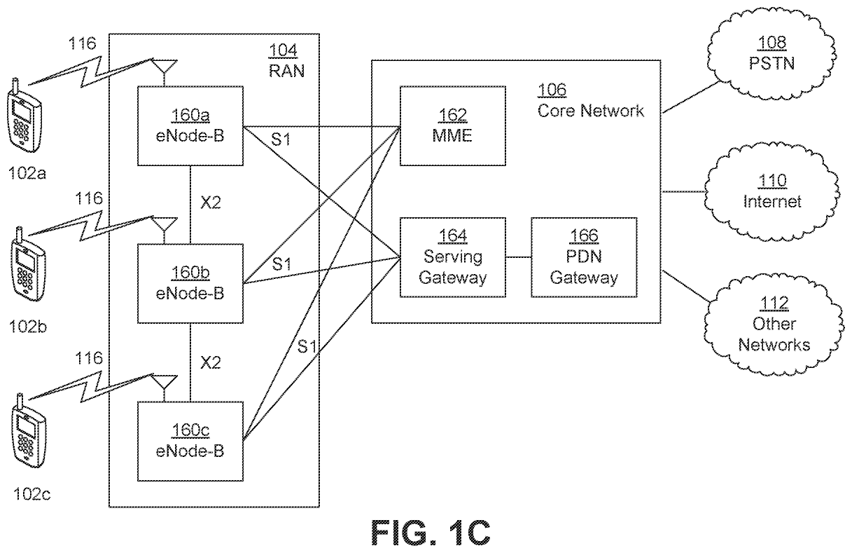

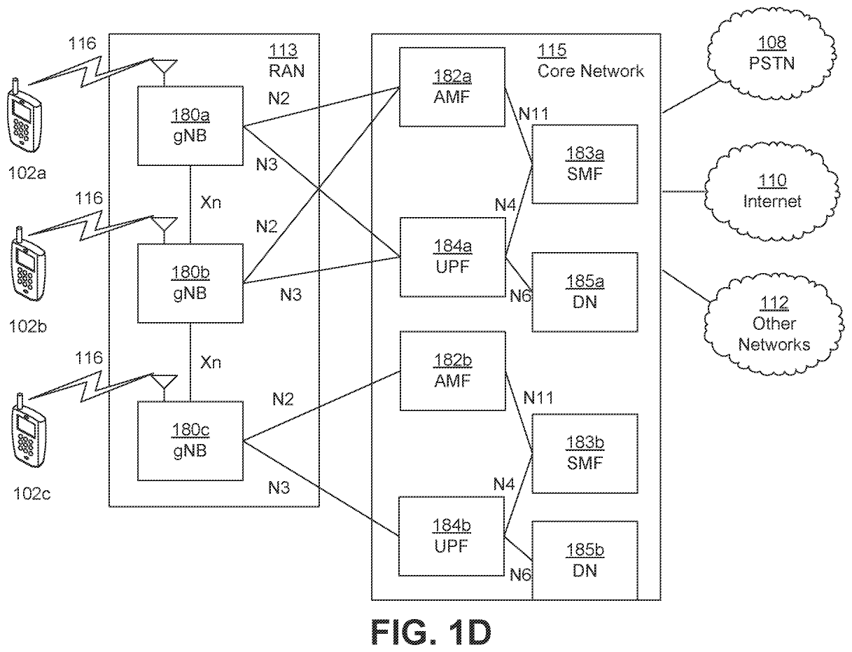

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a -d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a timer expiration herein may refer to determining that the time has occurred or that the period of time has expired.

Systems, methods, and instrumentalities are described herein that relate to data transfer with energy harvesting (EH).

A wireless transmit/receive unit (WTRU) associated with EH may be configured to send a request indicating a requested off time. The requested off time may correspond to a requested period of time associated with the WTRU entering a lower power operation (e.g., the WTRU powers off, operates in low power, and/or performs EH). The requested off time may correspond to a requested period of time associated with the WTRU stopping or pausing UL transmission, DL reception, and/or one or more other functions. The WTRU may receive a response (e.g., in response to the request). The response may be a message such as an EH response message. The response (e.g., the EH response message) may include information indicating one or more of: an off length of time (e.g., a period of time associated with the WTRU entering the lower power operation, where the off length of time may be the same or different than the requested off time); a configured grant (CG); resource(s) associated with the CG; or a CG validity time. The off length of time may be the length or duration of a time during which the WTRU may be or may stay in the lower power operation, where for example, the WTRU may exit the lower power operation if one or more conditions are satisfied or if the time period ends. The off length of time may be a time (e.g., time period) during which a WTRU harvests (e.g., obtains or derives) energy. The CG validity time may be a length of time or time period for which the CG resources are valid.

The WTRU may start a first time period (e.g., after receiving the response) based on the off length of time. The WTRU may start a second time period (e.g., after receiving the response) based on the CG validity time. The second time period (e.g., corresponding to the CG validity time) may begin after the first time period (e.g., corresponding to the off length of time received in the EH response) (e.g., the first period may be longer than the second time period). If at least the first time period and the second time period have not ended and one or more conditions are satisfied, the WTRU may transmit a power recovery indication in an uplink (UL) transmission (e.g., PUSCH transmission). The power recovery indication may be transmitted using resource(s) associated with the CG. The UL transmission (e.g., PUSCH transmission) may include an amount of UL data. The amount of UL data may be the amount of data that the WTRU may buffer. The UL transmission (e.g., the PUSCH transmission) may (e.g., may also) include a buffer status report.

The WTRU may receive an indication of a buffer threshold. In examples, the one or more conditions for transmitting a power recovery indication may be satisfied if UL data available for transmission exceeds the buffer threshold. In examples, the amount of UL data included in the UL transmission may be an amount of the UL data available for transmission that exceeds the buffer threshold. In examples, the one or more conditions may be satisfied if the WTRU has sufficient energy (e.g., a sufficient battery level) to transmit the amount of UL data that exceeds the buffer threshold. In examples, the one or more conditions may be satisfied if a power condition (e.g., the WTRU's battery level) is above a threshold (e.g., is above a battery level threshold).

EH may offer zero-energy consumption data communication. EH may impose intermittent connection drops due to battery shortage. If a certain condition is met (e.g., battery shortage), the RRC state or DRX/DTX configuration may be switched and a data transfer operation may be suspended. EH may be performed to charge the battery or capacitor of the WTRU in the changed RRC state (e.g., new RRC state) or in a changed DRX/DTX operation (e.g., new DRX/DTX operation).

If the state is transitioned or the DRX/DTX configuration is changed, protocol times (e.g., via all protocol timers) may be suspended and the user data maintained so that the transmitter and the receiver entities may resume data communication without data loss (e.g., any data loss) or with very small loss of data. If the WTRU wakes-up (e.g., if the WTRU has harvested enough energy to resume data communication and WTRU re-activates RF chain for the data communication), an “uplink recovery indication” may be indicated so that the WTRU and network may resume the data communication.

Many compelling use cases for long-battery-life devices have emerged. These may include various IoT devices, small form factor handsets, wearable devices, and implantable devices, etc. Passive and semi-passive receivers may be key enablers of these emerging use cases. The devices may be charged by a network via EH (e.g., in addition to the ultra-low power receiver technologies). The energy harvest enabled devices may not (e.g., may no longer need) to be equipped with large batteries but very limited capacity batteries or capacitors to a minimum amount of energy for data communication.

Examples of Discontinuous Reception (DRX) operations may be provided herein. DRX may be used for battery savings. During DRX, a WTRU may not monitor a DL control channel (e.g., PDCCH). In RRC connected mode, a WTRU may use connected mode DRX (C-DRX).

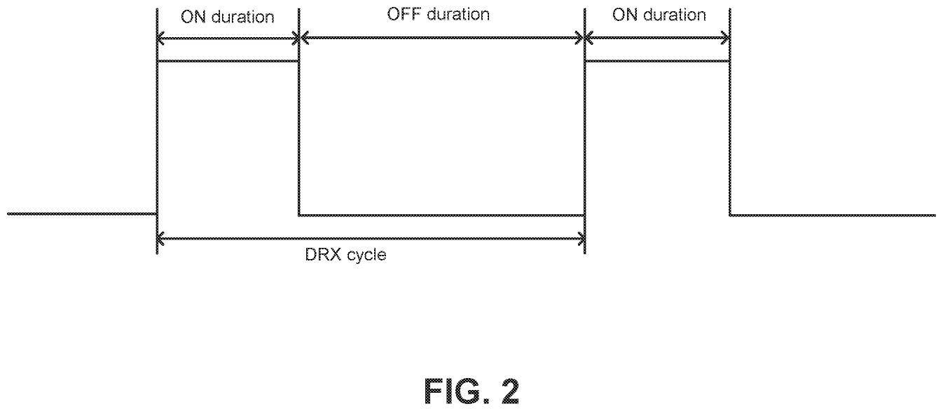

FIG. 2 illustrates an example of an ON duration and an OFF duration with a DRX cycle. A WTRU may monitor a configured PDCCH during an ON duration period and the WTRU may sleep (e.g., not monitor the PDCCH) during an OFF duration. A PDCCH may be used herein as a non-limiting example of a DL control channel.

A DRX cycle may be a cycle (e.g., a repetition or periodic repetition) of an ON duration and an OFF duration. A WTRU may monitor a PDCCH during an ON duration and a WTRU may skip monitoring a PDCCH (e.g., any PDCCH) during an OFF duration. A DRX cycle may be a short DRX cycle or a long DRX cycle. A WTRU may use a short DRX cycle for a period of time and (e.g., and then) a long DRX cycle. A DRX inactivity timer may determine or may be used to determine a time (e.g., in terms of TTI duration, after a PDCCH occasion in which a PDCCH (e.g., a successfully decoded PDCCH) indicates an (e.g., an initial) UL or DL user data transmission). The DRX inactivity timer may be used to determine when to go to an OFF duration. A DRX ON duration may be the duration at the beginning of a DRX cycle. An ON duration timer may determine or may be used to determine a number of (e.g., a consecutive number of) PDCCH occasion(s) that may be (e.g., or may need to be) monitored or decoded (e.g., by a WTRU). The PDCCH occasion(s) may be (e.g., or may need to be) monitored or decoded after wakeup from the DRX cycle or at the beginning of a DRX cycle. A PDCCH occasion may be a time period that may include a PDCCH (e.g., such as symbols, a set of symbols, a slot, or a subframe).

A DRX retransmission timer may determine or may be used to determine a number (e.g., a consecutive number) of PDCCH occasion(s) to monitor if retransmission is expected by the WTRU. A DRX retransmission timer may determine or may be used to determine a maximum duration until a DL retransmission is received or a maximum duration until a grant for UL retransmission is received. A DRX short cycle may be the first DRX cycle that the WTRU enters (e.g., after expiration of DRX inactivity timer). A WTRU may be in the short DRX cycle until the expiration of the DRX short cycle timer. If the DRX short cycle timer is expired, the WTRU may use a long DRX cycle. A DRX short cycle timer may determine or may be used to determine the number of subframe(s) (e.g., consecutive subframe(s)) for which the WTRU may follow the short DRX cycle (e.g., after the DRX inactivity timer has expired).

During an OFF duration, a WTRU may not measure or report CSI in a subframe configured to measure and/or report a periodic CSI reporting. A WTRU may (e.g., or may need to) monitor a PDCCH or PDCCH occasions during an active time. An active time may occur during an ON duration. An active time may occur during an OFF duration. An active time may begin during an ON duration and continue during an OFF duration. An active time and an active time of a DRX cycle may be used interchangeably herein. An active time may include the time while at least one (e.g., any one) of the following is true: a DRX timer is running (e.g., such as an ON duration timer, an inactivity timer, a retransmission timer (e.g., in the DL and/or the UL), or a random access (RA) contention resolution timer); a scheduling request is sent (e.g., on a PDCCH) and is pending; or a PDCCH indicates a transmission (e.g., new transmission) addressed to the C-RNTI of a MAC entity of the WTRU that has not been received (e.g., after successful reception of a RA response for the RA preamble not selected by the MAC entity among the contention based RA preamble).

Examples of a wake-up signal (WUS)/go-to-sleep signal (GOS) may be provided herein. A wake-up signal (WUS) and/or go-to-sleep signal (GOS) (WUS/GOS) may be used with a DRX operation. A WUS/GOS may be associated with one or more DRX cycles. A WUS/GOS may be transmitted and/or received (transmitted/received) prior to an associated time or part of a (e.g., an associated) DRX cycle.

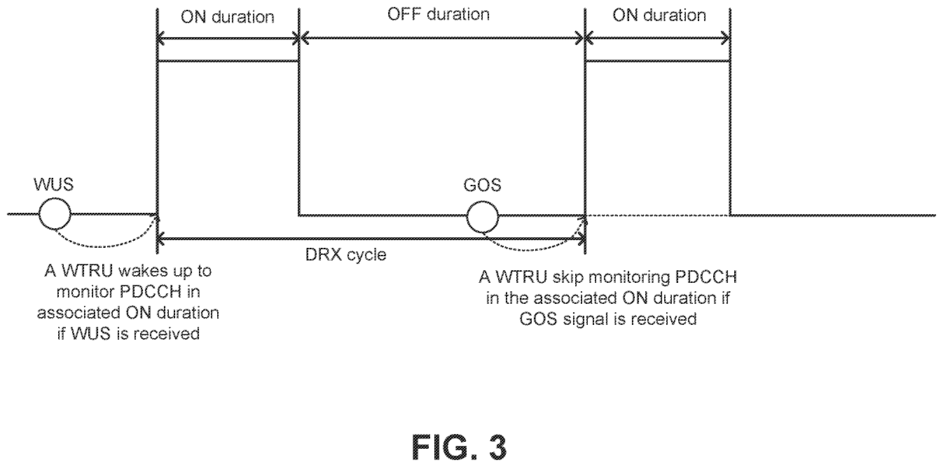

FIG. 3 illustrates an example of WUS and GOS with a DRX operation. If a WTRU receives a WUS, the WTRU may monitor a PDCCH in ON durations for one or more DRX cycles. If a WTRU receives a GOS, the WTRU may skip monitoring PDCCH in ON durations for one or more DRX cycles and may stay in sleep mode (e.g., deep sleep). In a system or network, either WUS or GOS may be used. In a system or network, both WUS and GOS may be used.

Examples of WTRU states and state transitions may be provided. A WTRU may be either in a RRC_CONNECTED state or in RRC_INACTIVE state if an RRC connection has been established. If this is not the case (e.g., no RRC connection is established), the WTRU may be in an RRC_IDLE state. The RRC states may be (e.g., may be further) characterized by one or more of the following: RRC_IDLE; RRC_INACTIVE; or RRC_CONNECTED. The term “state” herein may refer to an operating level of a WTRU.

For the RRC_IDLE state, a WTRU specific DRX may be configured (e.g., by upper layers). A WTRU controlled mobility may be based on network configuration. The WTRU may do one of more of the following: monitor short messages transmitted with P-RNTI over DCI; monitor a paging channel for CN paging using 5G-S-TMSI; perform neighboring cell measurements and cell (re-) selection; or acquire system information and send an SI request (e.g., if configured).

For the RRC_INACTIVE state, a WTRU specific DRX may be configured (e.g., by upper layers or by a RRC layer). A WTRU controlled mobility may be based on network configuration. The WTRU may store the WTRU inactive AS context. A RAN-based notification area may be configured by a RRC layer. The WTRU may do one or more of the following: monitor short messages transmitted with P-RNTI over DCI; monitor a paging channel for CN paging using 5G-S-TMSI and RAN paging using full-RNTI; perform neighboring cell measurements and cell (re-) selection; perform RAN-based notification area updates periodically and if moving outside the configured RAN-based notification area; or acquire system information and send a SI request (e.g., if configured).

For the RRC_CONNECTED state, a WTRU may store the AS context. Transfer of unicast data may be to or from the WTRU. At lower layers, the WTRU may be configured with a WTRU specific DRX. For WTRUs supporting CA, the WTRUs may use one or more SCells aggregated with the SpCell (e.g., for increased bandwidth). For WTRUs supporting DC, the WTRUs may use of one SCG aggregated with the MCG (e.g., for increased bandwidth). Network controlled mobility within NR and to/from E-UTRA may be provided. The WTRU may do one or more of the following: monitor short messages transmitted with P-RNTI over DC (e.g., if configured); monitor control channels (e.g., PDCCH) associated with the shared data channel to determine if data is scheduled for the shared data channel (e.g., PDSCH); provide channel quality and feedback information; perform neighboring cell measurements and measurement reporting; or acquire system information.

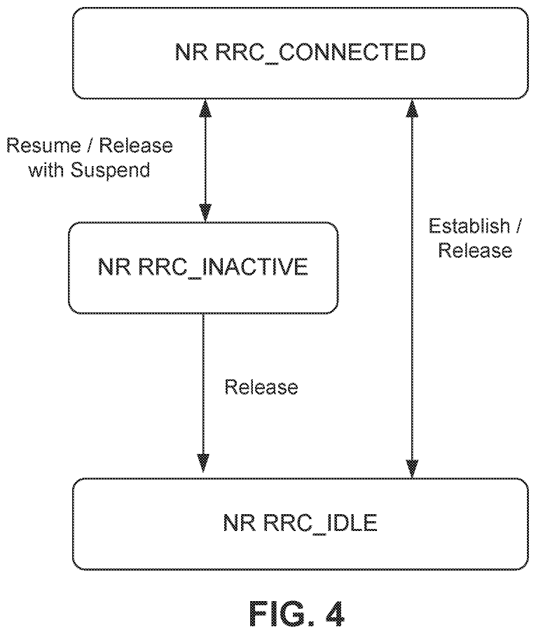

FIG. 4 illustrates an example of WTRU RRC state machine and state transitions (e.g., in NR). A WTRU may have (e.g., may have only) one RRC state (e.g., in NR) at one time. To perform the state transition from a RRC_IDLE to RRC_CONNECTED state, some RRC message exchanges may happen (e.g., in order of RRCSetupRequest from WTRU to network, RRCSetup from network to WTRU, and RRCSetupComplete from WTRU to network). For the state transition from the RRC_CONNECTED to RRC_INACTIVE state, the network may send a RRCRelease message with suspendConfig IE. The RRCRelease message may include RRC_INACTIVE related information towards the WTRU and (e.g., and then) the WTRU may move into the RRC_INACTIVE state. For the state transition from RRC_CONNECTED to RRC_IDLE state, the network may send a RRCRelease message without the suspendConfig IE towards the WTRU and (e.g., and then) the WTRU may move into the RRC_IDLE state. In examples, the WTRU may move from the RRC_CONNECTED state to the RRC_IDLE state if an error event happens (e.g., such as radio link failure detection before security context establishment).

Examples of radio link control (RLC) operations may be provided herein. A RLC entity may have at least one of the following different operation modes: Transparent Mode (TM); Unacknowledged Mode (UM); or Acknowledged Mode (AM).

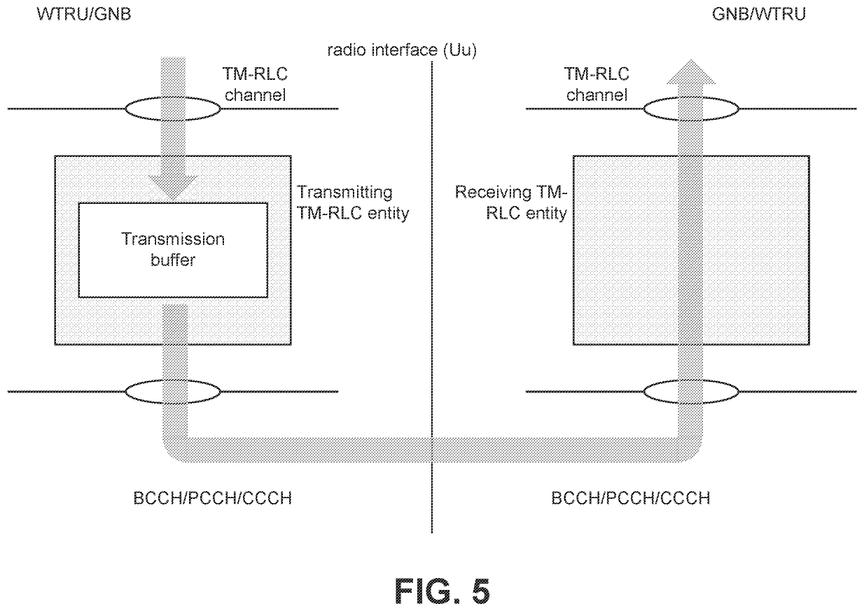

FIG. 5 illustrates an example of two TM peer entities. For the TM RLC, the TM RLC may function as a transmitting TM RLC or a receiving TM RLC. The transmitting TM RLC may submit a RLC SDU received the from the upper layer to the lower layer (e.g., without modification). The receiving TM RLC may submit a RLC PDU received from the lower layer to the upper layer (e.g., without modification).

For the UM RLC, the UM RLC may function as a transmitting UM RLC or a receiving UM RLC. The transmitting UM RLC may receive a RLC SDU (e.g., from the upper layer). If the RLC SDU is bigger than the payload size of the transmissible RLC PDU size, the transmitting UM RLC may segment the RLC SDU into more than one RLC PDU and may put a sequence number (SN) in the RLC PDU (e.g., so that the receiving UM RLC entity can reassemble the segments in order). If the RLC SDU is not bigger than the payload size of the transmissible RLC PDU size, the transmitting UM RLC may generate a RLC PDU including a complete RLC SDU. The transmitting UM RLC may submit the RLC PDU to the lower layer if the lower layer is ready to transmit RLC PDU.

The receiving UM RLC may receive a RLC PDU (e.g., from the lower layer). If the RLC PDU includes a segment of a RLC SDU, the receiving UM RLC may place the segment into a reassembly buffer in order of the SN and may generates a RLC SDU if the segments (e.g., all the segments) associated with the same RLC SDU are received at the reassembly buffer. If the RLC PDU does not include a segment of a RLC SDU, the receiving UM RLC may generate a RLC SDU by removing the UM RLC header from the RLC PDU. The receiving UM RLC may submit the RLC SDU to the upper layer if a complete RLC SDU is generated.

For the AM RLC, the AM RLC may function as a transmitting AM RLC or a receiving AM RLC. The transmitting AM RLC may be associated with a first transmission (e.g., initial transmission) and a second transmission (e.g., retransmission). The transmitting AM RLC may receive a RLC SDU (e.g., from the upper layer). If the RLC SDU is bigger than the payload size of the transmissible RLC PDU size, the transmitting AM RLC may segment the RLC SDU into more than one RLC PDU and may put a SN in the RLC PDU so that the receiving AM RLC entity can reassemble the segments in order. If the RLC SDU is not bigger than the payload size of the transmissible RLC PDU size, the transmitting AM RLC may generate a RLC PDU including a complete RLC SDU. The transmitting AM RLC may set the SN of the RLC PDU to send according to the state variable “TX_Next”. The transmitting AM RLC may submit the RLC PDU to the lower layer if the lower layer is ready to transmit the RLC PDU.

The transmitting AM RLC may receive a status PDU. If a status PDU indicates some AM RLC Data PDU (AMD) that needs to be re-transmitted (e.g., NACKed), the transmitting AM RLC may schedule the NACKed AMDs for a next transmission opportunity. If a status PDU indicates some AM RLC Data PDU (AMD) that needs to be re-transmitted (e.g., NACKed), the transmitting AM RLC may re-segment the retransmitting AMD into more than one AMD in the case that the AMD is bigger than the transmittable AMD size. If the status PDU confirms one or more successful reception of AMD, the transmitting AM RLC may remove the positively ACKed AMD(s) from the TX buffer.

The receiving AM RLC may receive a RLC PDU (e.g., from the lower layer). The receiving AM RLC may place the RLC PDU in a receiving buffer. The receiving buffer may be maintained by some state variables and may be reassembled by a RLC SDU with segments in the reception buffer if any segment exists in the buffer. The receiving AM RLC may submit the RLC SDU to the upper layer if a RLC SDU becomes ready to submit to the upper layer.

UL transmissions (e.g., PUSCH transmission(s)) may be dynamically scheduled by an UL grant in a DCI, or the transmission may correspond to a configured grant (e.g., Type 1 or Type 2). A configured grant (CG) may provide periodic resources (e.g., in time and/or frequency). A CG may be RRC configured. The CG resources may be available for transmission after configuration. The CG resources may be available for transmission after activation. In examples, a CG (e.g., Type 1) may be semi-statically (e.g., RRC) configured to operate without the detection of an UL grant in a DCI. Another CG (e.g., Type 2) may be semi-persistently scheduled (e.g., by an UL grant in a valid activation DCI).

Improvement of device's energy consumption has been a top priority task in wireless communications. Power saving techniques may include an ultra-low power wake-up receiver, which may offer almost-zero energy consumption and EH, which is the process by which energy may be derived by converting energy from external sources such as solar power, thermal energy, or kinetic energy.

Signaling exchanges may be interrupted if operating with EH if the WTRU runs out of harvested energy and may (e.g., may only) restart when the WTRU has harvested sufficient energy. Protocol enhancements to support operation on intermittently available harvested energy is described herein.

Examples herein may address one or more of the following: EH RRC Connection Establishment; Introduction of a new RRC state (e.g., a RRC_POWER_OFF state) and blind state transition to the RRC_POWER_OFF state; and resumption from the RRC_POWER_OFF state to the RRC_CONNECTED state.

EH enabled device data transfer may be interrupted due to an energy shortage (e.g., a battery shortage) as the devices may have small batteries or capacitors operating if using harvested ambient energy. The devices may temporarily drop a connection in the middle of data transfer. The devices may not (e.g., may not always) release the connection.

In examples, the network and WTRU may maintain a RRC connection. The connection state may be synchronized between the network and WTRU using RRC signaling exchanges.

EH devices' connection control may include the following: the network and WTRU may maintain RRC connection even after RRC connection temporary drops due to an energy shortage (e.g., a battery shortage) and the WTRU may resume the connection without initiating a RRC connection establishment procedure; the network and WTRU may have a means to release a RRC connection so that the EH device's RRC context can be released by the network; support of mobility may not be essential for the early stage; or the U-plane may be able to suspend data transfer even if the user activity is suddenly suspended (e.g., when in the middle of SDU reassembly) and resume the data transfer as if it was not suspended (e.g., the SDU reassembly is resumed without any data loss) at the receiver side.

Examples of changes in C-plane are described herein. An updated RRC state (e.g., a new) RRC state may be introduced on top of the existing RRC states. For example, the updated RRC state (e.g., the new RRC) state may be as follows: RRC_POWER_OFF: A WTRU specific DRX/DTX for this updated RRC state (e.g., new RRC state) may be configured by upper layers or by a RRC layer. WTRU may store the WTRU AS context. The WTRU may be harvested via an EH signal. The WTRU may not do anything else (e.g., neither paging monitoring, neighboring cell measurements, system information acquisition, nor idle/inactive measurement).

In the new state, the network and WTRU may maintain NAS context, AS context including radio bearer configuration, L2 configuration, and security context but not any PHY resources. The RRC connection may not be released (e.g., due to radio link failure (out-of-sync at PHY, max retry at ARQ)) and may be maintained until the RRC connection is released (e.g., explicitly released) by the network. The WTRU may autonomously enter the updated state (e.g., the new state) if detecting a power source failure (e.g., insufficient harvested energy.)

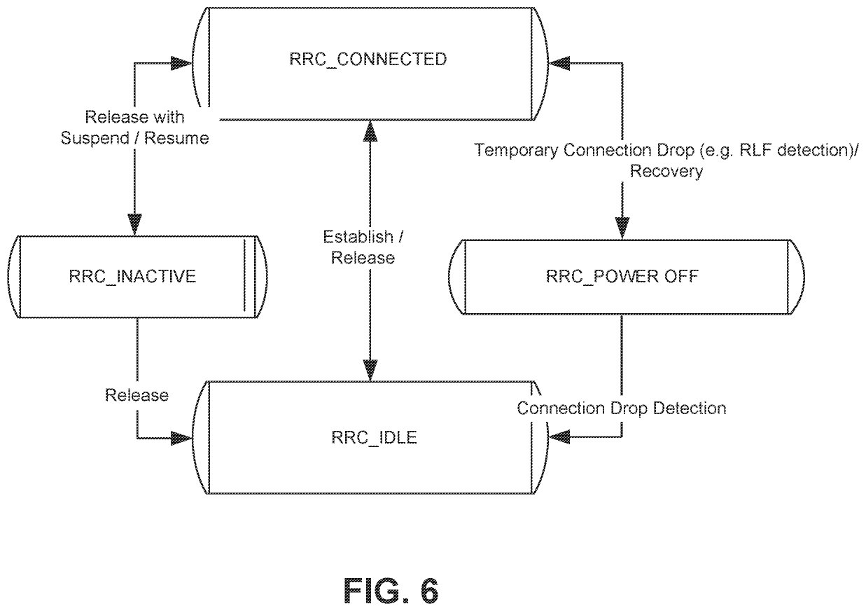

FIG. 6 illustrates an example of a RRC state machine for an EH enabled WTRU. The EH enabled WTRU may perform the state transitions between RRC_IDLE, RRC_CONNECTED, and RRC_INACTIVE states. WTRU may perform state transitions (e.g., in addition to the existing state transitions) between RRC_POWER_OFF, RRC_CONNECTED, and RRC_IDLE states (and potentially the RRC_INACTIVE state).

The state transition from RRC_CONNECTED to RRC_POWER_OFF state may take place due to a detection of a temporary connection drop (e.g., which is described below). The state transition from the RRC_POWER_OFF to RRC_CONNECTED state may take place if the WTRU is harvested sufficient energy to recover the RRC connection. For this state transition, the WTRU may signal an UL recovery indication (e.g., as described below).

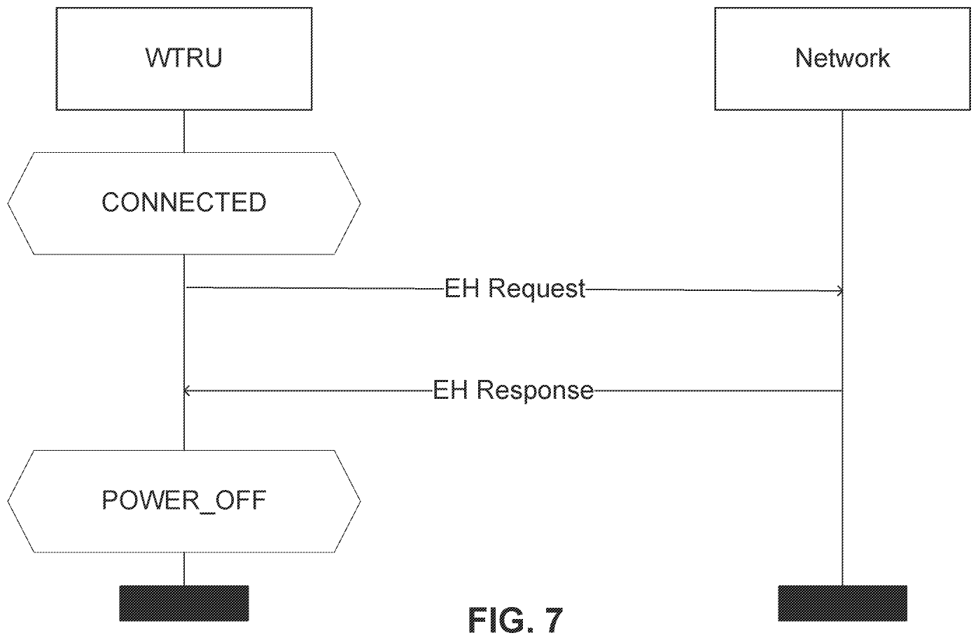

FIG. 7 illustrates an example of an EH notification or EH request for the case of a state transition from a CONNECTED to POWER_OFF state. If the WTRU performs the state transition from RRC_CONNECTED to RRC_POWER_OFF state, the WTRU may signal an EH notification request to the network and (e.g., and then) the network may send back a response (e.g., a EH response) (e.g., as shown in FIG. 7). The EH request message may include at least information related to how long the WTRU may go-away and when the WTRU may come back. The EH response message may include one of the following information: an identification of UL resource(s) to be used for the power recovery message transmission; how long the WTRU can stay in the RRC_POWER_OFF state; or how much data the WTRU can buffer in the POWER_OFF state so that the WTRU wakes up if the WTRU buffers more user data to transmit than the given data amount.

For information related to what UL resource(s) should be used for the power recovery message transmission, in examples, CG and/or RACH preamble may be used as UL resources. The UL resource information may include (e.g., may further include) a validity time of the UL resource. If the WTRU attempts to send the power recovery message within the validity time, the WTRU may use the UL resource given by the EH response message. For information related to how long WTRU can stay in the RRC_POWER_OFF state, the EH response message may signal how long WTRU can perform EH in the state.

The EH request message may be sent via at least one of an UL RRC message, UL MAC Control Element (CE), Uplink Control Information (UCI), or a specific UL PHY signaling (e.g., the notification may be signaled over a specific PHY, for example, a channel made and/or designated for this purpose).

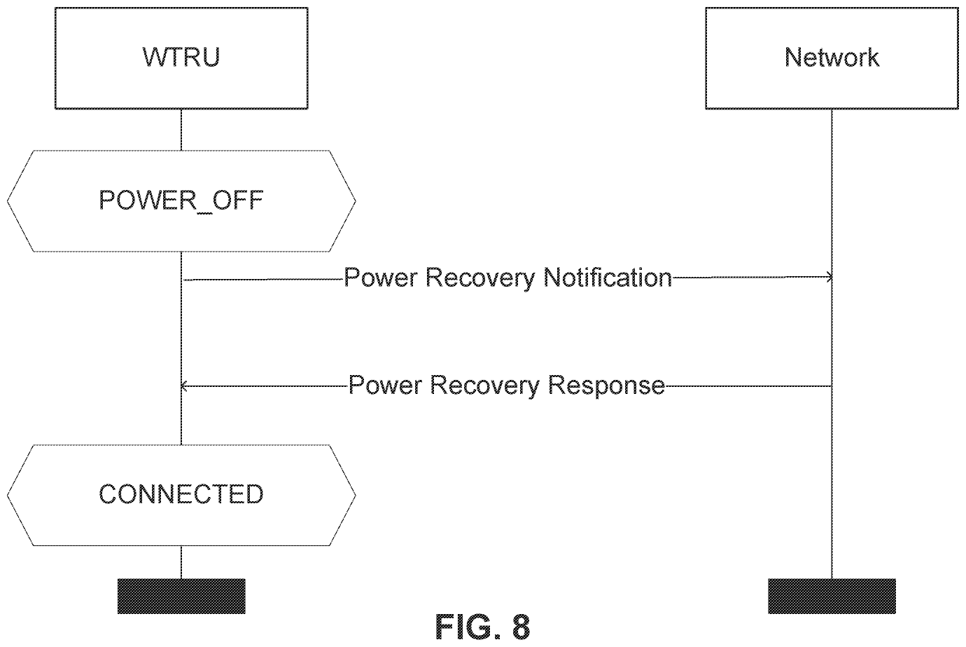

FIG. 8 illustrates an example of a power recovery notification for the case of state transition from a POWER_OFF to RRC_CONNECTED state. If the WTRU performs a state transition from the RRC_POWER_OFF to RRC_CONNECTED state, the WTRU may signal a power recovery notification message to the network and (e.g., and then) the network may send back a power recovery response message (e.g., as shown in FIG. 8).

The WTRU may determine whether the WTRU performs the power recovery notification procedure (e.g., whether to send a power recovery notification) or not based on one or more of a combination of the following criteria: energy level (e.g., battery level); coverage based; measurement based; or buffer status based.

For energy level (e.g., battery level), the WTRU may check if the WTRU has enough energy to perform the regular data transmissions and receptions for a certain amount of time.

For coverage based, the WTRU may check if the WTRU is in (e.g., is still in) the coverage of the previous serving cell/serving gNB where the WTRU moved into the RRC_POWER_OFF state. If WTRU is under the same serving cell or serving gNB coverage, then the WTRU may determine initiating a power recovery notification procedure. Otherwise, the WTRU may perform a RRC connection re-establishment procedure.

For measurement based, the WTRU may perform measurements in the RRC_POWER_OFF state and may send a MeasurementReport message if certain reporting criteria are met. The reporting criteria may include the conditions for the radio quality and/or radio strength. The reporting criteria may include (e.g., may also include) the energy level (e.g., the battery level) (e.g., as mentioned herein). The measurement report message may be used as a power recovery notification.

For buffer status based, the WTRU may check how much data is buffered in the transmission buffer (e.g. at PDCP and/or RLC) and (e.g., and then) the WTRU may check the energy level (e.g., the battery level) to determine if the WTRU has enough energy to transmit the buffered data (e.g., all the buffered data) or enough energy to transmit certain amount of data (e.g., and the data amount is given by network when WTRU moves into the RRC_POWER_OFF state). If WTRU has enough energy to transit the data, then the WTRU may determine to wake up and send a power recovery notification.

If the WTRU determines to send a power notification, the WTRU may perform UL resource selection, which may include one or more of the following: the WTRU may check if a CG is given when the WTRU moves into the RRC_POWER_OFF state; if the given CG is still valid (e.g., by checking whether the validify time has already elapsed or not from the point where WTRU moves into RRC_POWER OFF state); or if a timing advance (TA) is still valid. If CG is still valid, the UL CG may be used for the power recovery notification signaling. The WTRU may (e.g., may then) check the validity of TA. If the TA is valid (e.g., is still valid), then the WTRU may send a power recovery notification by using the CG.

If the CG is valid (e.g., is still valid) after the above checks, then the WTRU may send a power recovery notification by using the CG. For the case of CG, WTRU may send some user payload together with the power recovery notification via the CG. If CG is not valid (e.g., is not still valid), the WTRU may send a power recovery notification via a RA procedure. For the case of RA, the WTRU may check some criteria to determine whether 4-step RA or 2-step RA is used for the power recovery notification.

Examples of connection drop detection may be provided herein. The network may consider the WTRU in the RRC_POWER_OFF state is no longer available if the network does not receive an UL recovery indication (e.g., any UL recovery indication) for a certain amount of time. The time duration may be pre-configured by RRC signaling (e.g., either RRC dedicated signaling or system information). The time duration may be configured with value N, which may indicate that the configured time duration is N times of DRX/DTX cycles. The time duration may be configured with an absolute time value (e.g., 1.28 sec or 640 ms). In examples, if the WTRU does not send the UL recovery indication for the time duration, then the network may consider the WTRU to be no longer available, may release the AS context of the WTRU, and may assume the RRC state of the WTRU moved into the RRC_IDLE state.

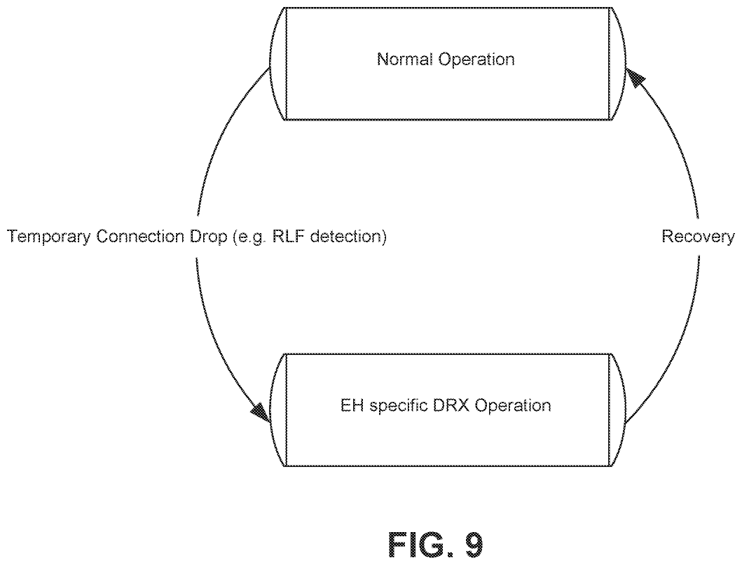

FIG. 9 illustrates an example of a EH DRX/DTX operation state machine. Examples of EH specific long DRX/DTX cycle configurations may be provided. The network may configure EH specific long DRX/DTX cycle, which may have much longer DRX/DTX cycles than the regular DRX/DTX cycles.

If the WTRU drops the connection temporarily (e.g., due to battery shortage), the network may assume the WTRU moves into the EH specific DRX/DTX cycle. The EH specific DRX/DTX cycle may give the WTRU some time to re-charge WTRU's battery via EH. The WTRU may come back to the network at the next ON duration of the EH specific DRX/DTX cycle if the WTRU has harvested energy enough to recover data communication. If the WTRU misses the next ON duration, then the WTRU may come back at the ON duration after the next. This applies for UL (DTX operation) and DL (DRX operation). For DTX operation, EH specific DTX configuration may be provided to the WTRU from the network and the configuration may provide the information of the DTX cycles.

This example may advantageously synchronize the WTRU and network, allowing the WTRU to recover data transmission at a time (e.g., specified time), allowing the network to utilize radio resources which otherwise may be assigned to the EH WTRU for other WTRU(s). If the WTRU recovers the data communication from the EH specific DRX/DTX operation, the WTRU may send an UL recovery indication (e.g., as described below).

A RRC connection may be released due the detection of the out-of-sync. The network may consider that the WTRU in EH specific DRX/DTX operation is out-of-sync (e.g., that the WTRU is no longer available in the current serving cell's coverage) if the network does not receive an UL recovery indication (e.g., any uplink recovery indication) for a certain amount of time. The certain amount of time may be determined based on a number of EH specific DRX/DTX cycles or absolute time duration. In examples, if the WTRU does not send the uplink recovery indication for N times of the EH specific DRX/DTX cycles or for the absolute time duration (either N or the absolute time duration defined for the out-of-sync detection), then the network may consider the WTRU is no longer camped on the current serving cell and may release the AS context of the WTRU.

The network side's RLM/RLF detection criteria may be revisited so that the network may not release a RRC connection but just release PHY resources. In examples, the network may maintain a time (e.g., via a timer) which may restart after any successfully received uplink signal (e.g., SRS, CSI report, any UCI, and/or PUSCH data). If the time (e.g., via a timer) expires, the network may consider that the WTRU has entered the RRC_POWER_OFF state or an EH specific DRX/DTX cycle.

The WTRU may send an uplink indication “degradation/unhappy” bit to the network, which may be sent with very low power. The indication may be provided more efficiently using uplink L1 control signaling (UCI), using a MAC header (MAC CE), a RLC header, or a PDCP header. The indication may be provided as part of a short RRC message.

A single bit may indicate that the WTRU is about to run out of power and transition to an off state/EH specific DRX/DTX cycle, which may allow the network to detect (e.g., immediately detect) the WTRU transition to the RRC_POWER_OFF state and/or longer DRX/DTX cycle. The detection of the transition may avoid the need to detect the issue based on RLM. Multiple unhappy bits may provide more information, for example, that an operation is degrading (e.g., an indication to suspend user activity for some time) or that the energy (e.g., battery) is running out (e.g., an indication to transfer data in energy efficient manner (e.g., schedule less power required resources or configure less bandwidth (and/or disabling DCCA)).

The WTRU may send an UL recovery indication to the network if the WTRU decides to recover the RRC connection (e.g., if the WTRU has harvested sufficient energy to resume the data communication). By the indication, the network may know that the WTRU has performed the state transition from the RRC_POWER_OFF to the RRC_CONNECTED state so the network and WTRU may resume the data communication.

The UL recovery indication may be provided by using uplink control signaling (UCI), using a MAC header (MAC CE), a RLC header, or a PDCP header. The indication may be provided as part of a short uplink RRC message (e.g., “RRCRecoveryRequest”).

The WTRU may be configured with some preconfigured resource(s) in an UL transmission for the WTRU to indicate the UL recovery indication. The preconfigured resource(s) may be a dedicated RACH preamble or PUSCH resource (e.g., CG) to send the indication. The preconfigured resources may include a set of the timing domain and frequency domain resources. The preconfigured resource may be periodic and the timing defined by the EH specific DRX/DTX. The network may identify the WTRU based on the preconfigured resource(s).

If the WTRU decides to recover, it may have to synchronize (e.g., synchronize again) with the network, which may imply performing at least one RRM measurement on the cell SSB. If the WTRU cannot identify the cell SSB of the previously camped cell, then the WTRU may drop the UL recovery indication and perform a cell search to find and camp on a new serving cell.

If the WTRU is equipped with a WUR/WUS radio, capable of uplink communication while the gNB is WUS capable, the WTRU may use the WUR resources to indicate the network the UL recovery indication. The WUR may be synchronized with the EH DRX/DTX cycle (e.g., as well), while the normal DRX/DTX cycle of the WTRU may be (e.g., may be as well) following a WUS. The UL WUS may be a physical layer WUR reserved resource signaled by a WUS capable gNB.

If the WTRU in RRC_POWER_OFF state, and while trying to recover, discovers that the WTRU is out of WUS coverage, the WTRU may fall back to the recovery procedure based on its main receiver protocol stack (e.g., the WTRU may perform the cell search by using its main receiver and protocol stack).

Examples of changes in U-plane are provided. Data buffer handling in the updated (e.g., new) RRC state/EH specific DRX/DTX may optionally flush PDUs (e.g., all PDUs), flush buffered data (e.g., all buffered data) in DU, or maintain the buffered data (e.g., all the buffered data) in RAN (e.g., CU and DU).

For flushing PDUs (e.g., all PDUs), if the state transitions into the RRC_POWER_OFF state or moves into an EH specific DRX/DTX cycle, the WTRU and network may discard buffered (e.g., all buffered) PDCP PDUs and the PDUs at lower layers of PDCP. The buffered PDCP SDUs may be used for data transfer resumption.

For flushing buffered data (e.g., all buffered data) in DU, if the state transitions into the RRC_POWER_OFF state or moves into an EH specific DRX/DTX cycle, the WTRU and network discard buffered (e.g., all buffered) RLC PDUs and the MAC PDUs. The WTRU and network may restart the data communication by using the buffered PDCP SDUs and PDCP PDUs.

For maintaining the buffered data (e.g., all the buffered data) in RAN (e.g., CU and DU), if the state transitions into the RRC_POWER_OFF state or moves into an EH specific DRX/DTX cycle, the WTRU and network may maintain the buffered data (e.g., all the buffered data) (PDCP SDUs, PDCP PDUs, RLC PDUs) apart from MAC PDUs. The WTRU and network may restart the data communication by using the maintained data (e.g., all the maintained data).

For flushing PDUs and flushing buffered data in DU, the buffered data (e.g., all the buffered data) may remain in the CU part of RAN so the WTRU and network may restart data communication without data loss even when WTRU is camped on a new serving cell when the WTRU wakes-up (e.g., moving back to RRC_CONNECTED state from RRC_POWER_OFF state or moving back to a normal operation from an EX specific DRX/DTX operation.)

For maintaining the buffered data in RAN, the network and WTRU may pause reassembly/reordering times (e.g., via reassembly/reordering timers) if indicating an L1 failure (e.g., HARQ failure or RLF detection) (e.g., as described herein). The WTRU and network may resume the times (e.g., via the timers) when the WTRU comes back in the U-plane operation (note: it implies that the receiving entities in the network and WTRU may remember the elapsed time for the suspended times (e.g., via each suspended timer) and the U-plane entities in the network and WTRU may remember values (e.g., all values) of the RLC protocol state variables and the PDCP protocol state variables.)

If the WTRU wakes-up, the transmitter entities in the WTRU and network may request the receiving entities at the peer end (e.g., the network or WTRU respectively) to send the status report so that the transmitter knows from where the transmitter should restart the data transmission (e.g., the transmitter sets the RLC poll bit to trigger the receiver to send an RLC STATUS PDU), or the receiving entities in the WTRU and network may autonomously send the status report (e.g., RLC STATUS PDU) when waking-up. The request may be necessary because it may be unclear, after temporarily switching off the (WTRU) transmitter, which PDUs (e.g., which RLC PDU SNs) have been successfully received at the network receiver because some transmitted RLC PDUs may or may not have been successfully received. Which PDUs may have been successfully received may be unclear due to data loss in either UL or DL (e.g., transmitted PDUs or ACKs). This may be for an AM radio bearer.

Status reports may be implicitly triggered by the receiving RLC entity (without RLC poll sent by the transmitter) based on recovery indications described herein. If the gNB receives the recovery indication, the gNB may send (e.g., immediately send) an RLC status report in the DL transmission (e.g., first DL transmission).

The WTRU may move into an RRC state (e.g., RRC_POWER_OFF) based on an energy-based condition/threshold being met, such as the WTRU determining that it may run out of energy (e.g., almost runs out of energy, energy is below a threshold, etc.). The WTRU may stay in the state even after the WTRU runs out of energy. In the RRC state, the WTRU may stop radio transmission and reception (and may suspend/stop any protocol timers which may be currently running), measurement, and/or radio link monitoring. In the RRC state, the WTRU may be charged by using harvested ambient energy.

The WTRU may move into a different DRX/DTX cycle (e.g., an EH specific DRX/DTX cycle) if the WTRU runs out of energy (e.g., almost runs out of energy), where the different DRX/DTX cycle may be different (e.g., longer) than a DRX/DTX cycle in use before the energy-based condition was met. The WTRU may stay in the DRX/DTX cycle even after the WTRU runs out of energy. In the OFF duration of the DRX/DTX cycle, the WTRU may stop radio transmission and reception (and may suspend/stop any protocol timers which may be currently running), measurement, and radio link monitoring. In the OFF duration of the DRX/DTX cycle, the WTRU may be charged by using harvested ambient energy. If the WTRU is not charged enough to resume data communication in an ON duration, the WTRU may continue being charged by using harvested ambient energy in the ON duration.

The WTRU may send an UL indication. The UL indication may be a recovery indication. The WTRU may send an UL indication when the WTRU (re-) wakes up (e.g., when the WTRU performs state transition from the RRC_POWER_OFF to RRC_CONNECTED state or the WTRU moves back to a normal operation from the EH specific DRX/DTX cycle). The UL indication may indicate that the WTRU wakes up, recovers the RRC connection, and restarts data communication. The UL indication may be signaled via either uplink control signal (UCI), a MAC header (MAC CE), a RLC header, a PDCP header, a PDCP control PDU, or an UL RRC message. The UL indication may indicate one or more of the following information: the identity of the WTRU; the amount of buffered data to be sent (e.g., BSR information); or the PHR. The UL indication may be sent via preconfigured resource(s). The preconfigured resource(s) may be a RACH preamble or a PUSCH resource.

The WTRU and network may maintain the buffered data. The WTRU and network may maintain (e.g., only the) PDCP SDUs (e.g., discarding PDCP PDUs and all data below PDCP layer). The WTRU and network may maintain (e.g., only the) PDCP SDUs and PDCP PDUs (e.g., discarding RLC SDUs, RLC PDUs, and MAC PDUs), or the WTRU and network may maintain buffered data (e.g., all buffered data) including or not including MAC PDUs.

The WTRU and network may restart data communication by using the maintained data. The WTRU and network may restart transmissions and receptions of PDCP SDUs maintained in the buffers. The WTRU and network may restart transmissions and receptions of PDCP PDUs (e.g., either generated from the maintained PDCP SDUs or the maintained PDCP PDUs themselves). The WTRU and network may restart transmissions and receptions of the maintained data (e.g., all the maintained data) at PDCP, RLC, and optionally MAC.

The WTRU and network may stop or suspend any running protocol times (e.g., protocol timers) at U-plane entity/entities. The WTRU and network may stop running protocol times (e.g., protocol timers) at PDCP, RLC, and optionally MAC (e.g., if the WTRU and network restart transmissions and receptions of PDCP SDUs maintained in the buffers). The WTRU and network may suspend any running protocol times (e.g., protocol timers) at PDCP and may stop any running protocol times (e.g., protocol timers) at RLC and optionally MAC if the WTRU and network restart transmissions and receptions of PDCP PDUs maintained in the buffers. The WTRU and network may suspend any running protocol times (e.g., protocol timers) at PDCP, RLC, and optionally MAC if the WTRU and network restart transmissions and receptions of the maintained data (e.g., all the maintained data) at PDCP, RLC, and optionally MAC.

The transmitting entities in the WTRU and network may request the receiving entities at the peer end (e.g., network or WTRU) to send a status report (e.g., the transmitting entity sets a poll bit). The status report may indicate from where the transmitter entities may (e.g., may need to) restart data transmission. The status report may indicate positive ACK(s) and/or NACK(s).

When restarting, the receiving entities in the WTRU and network may send a status report without receiving a polling request from the transmitter. The status report may indicate from where the transmitter entities may (e.g., may need to restart) data transmission. The status report may indicate positive ACK(s) and/or NACK(s).

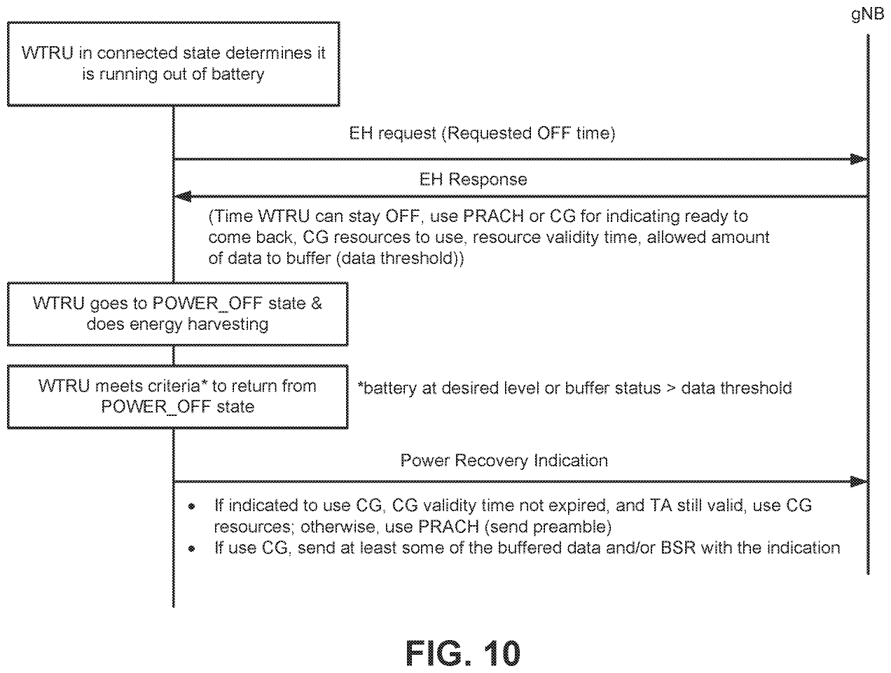

FIG. 10 illustrates an example for power savings and/or EH, where one or more of the illustrated features may be performed. A WTRU (e.g., a WTRU in a connected state which may be an RRC connected state) may determine its battery or other stored energy is running low (e.g., determine that an energy-based threshold condition is met). Battery or battery level may be used herein for exemplary purposes to represent energy (e.g., energy level) or stored energy (e.g., stored energy level) that may be in any form. RRC_CONNECTED may be used herein to represent a connected state or an RRC connected state.

In examples, a WTRU may determine its battery or battery level (e.g., energy or stored energy level) is below a threshold. The threshold may be configured. The WTRU, based on the battery level being below the threshold, may send a request (e.g., to a gNB) to go to a power off state, a low power state, an EH state, or any other state in which the WTRU may stop or pause (e.g., suspend) UL transmission, DL reception, and/or one or more other functions. The request is referred to herein as an EH request for exemplary purposes, but any other name may be used.

A WTRU may be configured to send a request (e.g., an EH request). The request (e.g., EH request) may include (e.g., indicate) a requested OFF time. The requested OFF time may correspond to an amount of time (e.g., a time period or length of a time period) for which the WTRU may enter a lower power operation (e.g., go to a power off state, a low power state, an EH state, or any other state in which the WTRU may stop or pause UL transmission, DL reception, and/or one or more other functions). The requested OFF time may correspond to a period of time (e.g., time period or length of a time period) during which the WTRU may stop or pause (e.g., suspend) UL transmission, DL reception, and/or one or more other functions.

A power off state (e.g., POWER_OFF state) may be used herein to represent a state in which the WTRU shuts off one or more functions to save power. A power off state may be used interchangeably herein with a lower power operation, low power, or ultra low power state. A power off state may be used interchangeably herein with an EH state and may be a state or a time (e.g., time period or time duration) during which a WTRU harvests (e.g., obtains or derives) energy. The WTRU may harvest energy from a signal or waveform, such as a signal or waveform intended for that purpose. The WTRU may use a separate receiver (e.g., from the one used for data reception) for EH. A power off state may be used to represent a state or a time during which a WTRU may stop or pause UL transmission, DL reception, and/or one or more other functions. The power off state may be referred to herein as the OFF state. EH may be used by the WTRU to increase its battery (e.g., energy or stored energy) level. Increasing a battery level may correspond to charging the battery.

The WTRU may receive (e.g., in response to the EH request) a message such as an EH response message. The message (e.g., EH response message) may include an EH configuration or EH configuration information. The EH configuration or EH configuration information may indicate how the WTRU should obtain energy via EH. The message (e.g., EH response message) may include information indicating at least one of the following: an off length of time (e.g., a time period or time duration associated with the WTRU lower power operation, where the off length of time may be the same or different than the requested off time); a type of resource (e.g., a CG or a PRACH); resource(s) associated with the CG; a resource (e.g., CG) validity time; or an amount of data (e.g., an allowed amount of data that may be buffered). The message may be referred to herein as an EH response message. Any other message or DL transmission may be used (e.g., and still be consistent with the examples herein). For example, the message may be a RRC release message (e.g., RRCRelease). The RRCRelease (e.g., RRC connection release) message may include any of the information described herein for an EH response message.

The off length of time may be the length or duration of a time during which the WTRU may be or may stay in the lower power operation (e.g., in the power off state). In examples, the WTRU may exit the lower power operation (e.g., the power off state) if one or more conditions are satisfied or if the time period ends. The off length of time may be a time (e.g., time period) during which a WTRU performs EH. The WTRU may start a first period (e.g., timer), for example, after receiving the EH response, based on (e.g., corresponding to) the off length of time.

The type of resource may be a PRACH or a CG. The resource may be used by the WTRU to indicate when the WTRU is ready to return, or is returning, from the lower power operation (e.g., the power off state).

If the type of resource is PRACH, the WTRU may transmit a PRACH preamble to indicate the WTRU is returning or ready to return from the lower power operation (e.g., the power off state). The WTRU may use at least one of a specific (e.g., configured) preamble, resource in time, or frequency for this purpose. The WTRU may be configured with a set of one or more preambles or a set of PRACH resources (e.g., time and or frequency domain information or resources) and may choose a preamble and/or a resource from the set for the transmission. The set of one or more preambles or PRACH resources may be indicated in the EH response.

If the type of resource is a CG, the WTRU may transmit using the CG to indicate the WTRU is returning or is ready to return from the lower power operation (e.g., the power off state). The WTRU may transmit a PUSCH using the CG.

A power recovery indication may be or may include an indication that the WTRU is returning or ready to return from the lower power operation (e.g., power off state) if at least the off length of time and the CG validity have not ended and one or more conditions are met (e.g., as described herein). The WTRU may transmit the power recovery indication using the PRACH preamble and PRACH resource or using the CG.

The CG or CG resources (e.g., provided in the EH response) may be or may indicate one or more resources that the WTRU may use for transmitting the power recovery indication. The power recovery indication may be transmitted using a PUSCH.

The resource validity time (e.g., CG validity time) may be a length of time or time period for which the CG resources are valid. The WTRU may start a second time period corresponding to the CG validity time (e.g., when or after the WTRU receives the EH response or when or after the WTRU receives the CG validity time (e.g., in the EH response)). The second time period (e.g., corresponding to the CG validity time) may begin a delay time after the WTRU starts the first period (e.g., corresponding to the off length of time after receiving the EH response) (e.g., the first time period may be longer than the second time period). The second time period (e.g., corresponding to the CG validity time) may begin when, after, or relative to the time when the WTRU receives or acknowledges the EH response. At least part of the EH response may be received in a MAC-CE or a DCI.

The amount of data may be the amount of data that the WTRU may buffer (e.g., may be allowed to buffer). The amount of data may be indicated by a threshold (e.g., a buffer threshold). If the amount of data the WTRU has to transmit (e.g., the amount of UL data buffered or the WTRU's buffer status) exceeds the buffer threshold, the WTRU may send a power recovery indication.

The WTRU may leave or return from the lower power operation (e.g., power off state) and/or transmit a power recovery indication (e.g., to the gNB) if one or more of the following conditions are satisfied: the WTRU's power condition (e.g., battery level) is above a power level threshold (e.g., a battery level threshold); the amount of UL data the WTRU has to transmit (e.g., the data in the WTRU's UL buffer or the WTRU's buffer status) exceeds the first buffer threshold (e.g., the buffer threshold in the EH response); or the WTRU's energy (e.g., battery level) is sufficient for transmitting at least a second amount of data (e.g., the amount of UL data that exceeds the first buffer threshold).

In examples, the WTRU may have X amount of data to transmit and the first data threshold is Y. The WTRU may leave or return from the lower power operation (e.g., the power off state) and/or transmit a power recovery indication if the WTRU's energy (e.g., battery level) is sufficient for transmitting the excess data over the threshold Y (e.g., X-Y data). The WTRU may transmit X-Y or more than X-Y (e.g., based on available battery/energy).

The WTRU may leave or return from the lower power operation (e.g., the power off state) and/or transmit a power recovery indication (e.g., to the gNB using a CG or CG resource), if one or more of the following conditions is satisfied: the resource type (e.g., in the EH response) is CG; a CG and/or one or more CG resources are configured for the indication (e.g., by the EH response); the CG validity time period has not expired; the WTRU's power level (e.g., battery level) is above a power (e.g., battery level) threshold; the amount of UL data the WTRU has to transmit (e.g., the data in the WTRU's UL buffer or the WTRU's buffer status) exceeds a first data threshold (e.g. the data threshold in the EH response); the WTRU's energy (e.g., battery level) is sufficient for transmitting at least a second data threshold amount of data (e.g., the amount of UL data that exceeds the first buffer threshold), where the second data threshold may be the same or different as the first data threshold; or the WTRU's timing advance (TA) value is still valid (e.g., the WTRU is uplink time aligned with the current serving cell) and/or a time alignment period has not expired.

If the WTRU uses a CG to send the power recovery indication, the WTRU may include at least some of the WTRU's buffered data and/or a buffer status report (BSR) with the indication (e.g., in the PUSCH that includes the indication.) The WTRU may include a power level (e.g., battery level) with the indication. The WTRU may send an indication (e.g., with the power recovery indication) indicating how much data the WTRU can transmit (e.g., based on its battery level).

A power recovery message may be used to send a power recovery indication. Power recovery message and power recovery indication may be used interchangeably herein. A power recovery indication may be a power recovery indication message.

If a (e.g., at least one) condition for using a CG for transmitting a power recovery indication is not satisfied (e.g., no CG resources provided, the CG validity time has expired, the TA is invalid, or the time alignment time period has expired), the WTRU may use a PRACH preamble and/or PRACH resource for sending the power recovery indication.

The WTRU may send a buffer status report (BSR) in a message (e.g., msg3) of a RA procedure. The message (e.g., msg3) may be in a PUSCH transmitted on resources granted by a RA response received in response to the preamble transmission. The BSR may be included in a BSR MAC-CE in the transmission.

If the WTRU leaves or returns from the power off state, it may go to a connected state. If the WTRU leaves or returns from the power off state, the WTRU may resume at least one of an UL transmission, a DL reception, or one or more functions that were paused or suspended in the power off state.

In a connected state (e.g., RRC connected state), a WTRU may transmit and/or receive information (e.g., data and/or control signaling) to and/or from a gNB or other network node.

In examples, the WTRU may leave or return from the power off state and/or transmit a power recovery indication (e.g., to the gNB) based on a measurement (e.g., based on RSRP). The RSRP may be a RSRP measurement of a SSB (e.g., such as an RSRP measurement of secondary sync signal (SSS) that may be part of a SSB).

If a SS-RSRP (e.g., SS-RSRP of all SSBs) is/are below a threshold, the WTRU may stay in the power off state. The WTRU may stay in the power off state since the WTRU may not be able to send data when the link quality is low. The WTRU may (e.g., may eventually) do at least one of declare out of service and/or perform cell selection (e.g., cell search and/or PLMN search) or reselection. Following cell selection or reselection, the WTRU may initiate a RRC connection re-establishment procedure for connection recovery. If at least one SS-RSRP (e.g., RSRP of SSS of at least one SSB) is above a threshold, the WTRU may leave or return from the power off state and/or transmit a power recovery indication (e.g., if one or more other conditions as described herein for leaving or returning from the power off state and/or transmitting a power recovery indication are also satisfied).

A measurement report such as a first measurement report (e.g., an existing measurement report) or a second measurement report (e.g., new measurement report) may be used to send the power recovery indication. At least one information element (IE) (e.g., one new information element) may be included in the measurement report for the power recovery indication. A message (e.g., new message) may be used for the power recovery indication. The WTRU may include battery or energy level information in the measurement report or other (e.g., new) message(s) (e.g., in addition to one or more radio link quality measurements (e.g., one or more measured results)).

In examples related to power saving/EH procedures, a WTRU may do one or more of the following: the WTRU may be configured to send a request including information indicating a requested off time; the WTRU may receive a message (e.g., response to the request) including information indicating at least one of: an off length of time (e.g., a period of time associated with the WTRU entering the lower power operation, where the off length of time may be the same or different than the requested off time), a resource type (e.g., a CG), a buffer threshold, resources for a CG, or a validity time (e.g., CG validity time); the WTRU may (e.g., after receiving the message or response) start a first time period based on the off length of time and/or if the resource type is CG, the WTRU may start a second time period (e.g., after the first time period) based on the validity time; the WTRU may receive an EH signal or waveform during at least part of the first time period; or if at least one (e.g., all) of the following conditions are satisfied: if the first time period (e.g., corresponding to the off length of time) has not ended, if the resource type is CG and the second time period (e.g., corresponding with the CG validity time) has not ended, if UL data available for transmission exceeds the buffer threshold, if the WTRU has enough energy (e.g., has a sufficient battery level) to send the excess data over the buffer threshold in the UL transmission (e.g., the amount of UL data included in the UL transmission may be an amount of the UL data available for transmission that exceeds the buffer threshold), or if a power condition (e.g., the WTRU's battery level) is above a power threshold (e.g., is above a battery level threshold), the WTRU may transmit a power recovery indication in an UL transmission (e.g., in a PUSCH transmission) using a resource associated with the CG and include at least some of the UL data for transmission or a buffer status report in the UL transmission (e.g., in the PUSCH transmission).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-14. (canceled)

15. A wireless transmit/receive unit (WTRU) associated with energy harvesting, comprising:
a processor configured to:
send a request, wherein the request indicates a requested off time;
receive a response, wherein the response comprises information indicating an off length of time, a configured grant (CG), a resource associated with the CG, and a CG validity time;
start a first time period corresponding to the off length of time;
start a second time period corresponding to the CG validity time;
receive an energy harvesting signal during the first time period; and
based on the first time period and the second time period not ending and one or more conditions being satisfied, transmit a power recovery indication in an uplink (UL) transmission using the resource associated with the CG, wherein the UL transmission includes an amount of UL data.

16. The WTRU of claim 15, wherein the processor is further configured to:
receive an indication of a buffer threshold, wherein the one or more conditions are satisfied based on UL data available for transmission exceeding the buffer threshold.

17. The WTRU of claim 16, wherein the amount of the UL data included in the UL transmission is an amount of the UL data available for transmission that exceeds the buffer threshold.

18. The WTRU of claim 17, wherein the one or more conditions are satisfied further based on the WTRU having sufficient energy to send the amount of the UL data available for transmission that exceeds the buffer threshold.

19. The WTRU of claim 15, wherein the one or more conditions are satisfied based on a power condition of the WTRU being above a threshold.

20. The WTRU of claim 19, wherein the power condition of the WTRU being above the threshold is a battery level of the WTRU being above the threshold.

21. The WTRU of claim 15, wherein the first time period is longer than the second time period.

22. The WTRU of claim 15, wherein the processor is further configured to:
determine that a battery level of the WTRU is below a threshold, wherein the request of the requested off time is sent based on the battery level of the WTRU being below the threshold.

23. A method implemented in a wireless transmit/receive unit (WTRU) associated with energy harvesting, comprising:
sending a request, wherein the request indicates a requested off time;
receiving a response, wherein the response comprises information indicating an off length of time, a configured grant (CG), a resource associated with the CG, and a CG validity time;
starting a first time period corresponding to the off length of time;
starting a second time period corresponding to the CG validity time;
receiving an energy harvesting signal during the first time period; and
based on the first time period and the second time period not ending and one or more conditions being satisfied, transmitting a power recovery indication in an uplink (UL) transmission using the resource associated with the CG, wherein the UL transmission includes an amount of UL data.

24. The method of claim 23, further comprising:
receiving an indication of a buffer threshold, wherein the one or more conditions are satisfied based on UL data available for transmission exceeding the buffer threshold.

25. The method of claim 23, wherein the amount of the UL data included in the UL transmission is an amount of the UL data available for transmission that exceeds the buffer threshold.

26. The method of claim 25, wherein the one or more conditions are satisfied further based on the WTRU having sufficient energy to send the amount of the UL data available for transmission that exceeds the buffer threshold.

27. The method of claim 23, wherein the one or more conditions are satisfied based on a power condition of the WTRU being above a threshold.

28. The method of claim 27, wherein the power condition of the WTRU being above the threshold is a battery level of the WTRU being above the threshold.

29. The method of claim 23, wherein the first time period is longer than the second time period.

30. The method of claim 23, further comprising:
determining that a battery level of the WTRU is below a threshold, wherein the request of the requested off time is sent based on the battery level of the WTRU being below the threshold.
